(19) United States
(12) Patent Application Publication
(10) Pub. No.: US 2011/0128202 A1
(43) Pub. Date: Jun. 2, 2011

(54) ANTENNA WITH SUPERSTRATE PROVIDING HIGH-GAIN AND BEAM WIDTH CONTROL

(75) Inventor: Jeong-Ho JU, Seoul (KR)

(73) Assignee: Electronics and Telecommunications Research Institute, Daejeon-si (KR)

(21) Appl. No.: 12/955,817

(22) Filed: Nov. 29, 2010

(30) Foreign Application Priority Data
Nov. 30, 2009 (KR) 10-2009-0116987

(51) Int. Cl. H01Q 1/38; H01Q 13/10; H01Q 13/00; H01Q 9/16

(52) U.S. Cl. 343/767; 343/700 MS; 343/772; 343/793

(57) ABSTRACT

An antenna employed in a base station is provided. The antenna comprises a feed antenna configured to feed power, and a superstrate configured to be located on an upper portion of the feed antenna and have a conductive pattern for increasing a gain and beam width control on a surface of a dielectric substrate. Accordingly, gain increase and beam width control of the antenna can be simultaneously realized.

### CROSS-REFERENCE TO RELATED APPLICATION(S)

This application claims the benefit under 35 U.S.C. §119(a) of Korean Patent Application No. 10-2009-0116987, filed on Nov. 30, 2009, the entire disclosure of which is incorporated herein by reference for all purposes.

### BACKGROUND

1. Field

The following description relates to an antenna which is employed in a base station or the like.

2. Description of the Related Art

Generally, to increase a gain of an antenna of a base station which requires high-gain radiation characteristics and beam width control, an array antenna comprising a number of patch antennas is used.

However, in an array antenna, as the number of patch antennas increases, energy loss due to patch antenna feed increases proportionally. Consequently, the overall efficiency of the array antenna is reduced. Moreover, to obtain an appropriate gain and radiation pattern, an interval between patch antennas and a signal phase fed to the patch antennas should be finely adjusted, resulting in complicating a structure of the array antenna.

In addition, to increase the antenna gain, an electromagnetic band-gap (EBG) type of antenna which has dielectrics with a high permittivity regularly arranged at an upper portion of the antenna, and a Fabry-Perot cavity type of antenna which is formed by placing a metallic grid on an upper portion of a general patch antenna have been introduced.

The above mentioned techniques are advantageous in that a feed structure is simple and, unlike an array antenna, gain can be increased with only a single feed. However, these methods have difficulties in beam width control. Furthermore, since a gain of the antenna is maximized when a distance between a superstrate and a ground plane is half-wave, the volume of the antenna is disadvantageously increased.

### SUMMARY

The following description relates to an antenna which can simultaneously achieve increase of gain, beam width control, and high front-to-back ratio (FBR).

In one general aspect, provided is an antenna including: a feed antenna configured to feed power; and a superstrate configured to be located on an upper portion of the feed antenna and include a conductive pattern for increasing a gain and beam width control on a surface of a dielectric substrate.

Other features and aspects will be apparent from the following detailed description, the drawings, and the claims

### BRIEF DESCRIPTION OF THE DRAWINGS

FIG. 1 is a diagram illustrating a cross-sectional view of an example of an antenna.

FIG. 2 is a diagram illustrating a cross-sectional view of an example of a unit cell of a superstrate shown in FIG. 1.

FIGS. 3A to 3D are diagrams illustrating examples of various shapes of the unit cell of FIG. 2.

FIG. 4 is a diagram illustrating an example of arrangement of the unit cells of FIG. 1.

FIG. 5 is a diagram illustrating another example of arrangement of the unit cells of FIG. 4.

FIG. 6 is a diagram illustrating an example of how a feed antenna feeds a signal in consideration of a matching characteristic of the antenna of FIG. 1.

FIG. 7 is a diagram illustrating a cross-sectional view of an example of the antenna of FIG. 1 further including a metal wall.

FIGS. 8 and 9 are diagrams illustrating graphs showing gain cell and beam steering characteristics of an antenna with respect to the change in the number of arranged unit cells and the occurrence of a metal wall in a superstrate.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

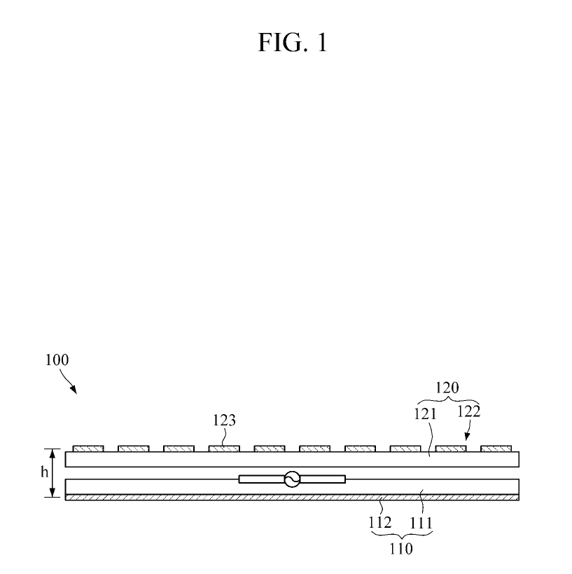

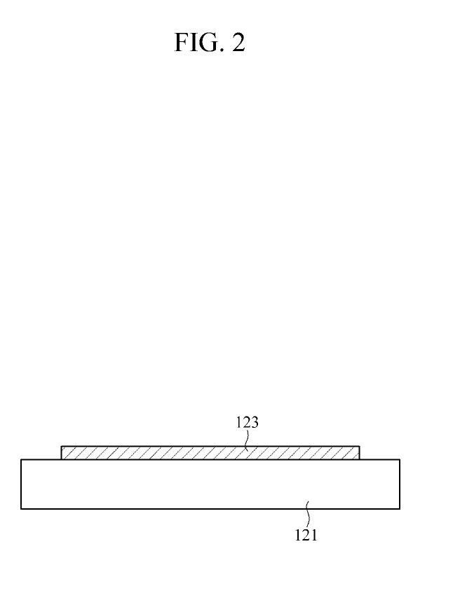

FIG. 1 illustrates a cross-sectional view of an example of an antenna. FIG. 2 illustrates a cross-sectional view of an example of a unit cell of a superstrate shown in FIG. 1.

Referring to FIGS. 1 and 2, the antenna 100 includes a feed antenna 110 and the superstrate 120. The feed antenna 110 is to feed power to the antenna 100. The feed antenna 110 may include a dielectric substrate 111 and a ground plane 112. The ground plane 112 is formed on one surface of the dielectric substrate 111.

The feed antenna 110 may have a variety of structures. For example, the feed antenna 110 may be a patch antenna, a dipole antenna, a slot antenna or a waveguide antenna. A patch antenna is formed by placing a metal patch on an upper side of a ground plane. A dipole antenna is formed by installing two linear conductors on a feed point in parallel, and emits or receives waves. A slot antenna is formed by making a slot on a flat conductive substrate and feeding power to the slot, thereby acting as a radiator of waves. A waveguide antenna has a funnel-shaped end which extends outward in a rectangular or circular form.

The superstrate 120 is formed on an upper portion of the feed antenna 110 and has a certain height of h from the ground plane 112. The superstrate 120 includes a dielectric substrate 121 and a conductive pattern 122. The conductive pattern 122 may be formed on a surface of the dielectric substrate 121 with a particular shape and intervals to achieve a gain increase and beam width control of the antenna 100. It is beneficial for the superstrate 120 to be easily formed with an economical printed circuit board (PCB) technique.

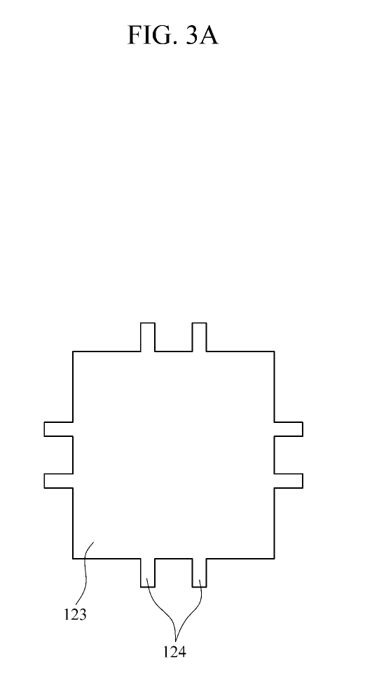

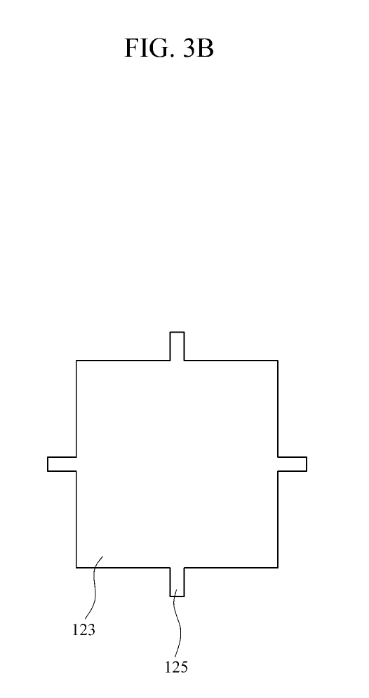

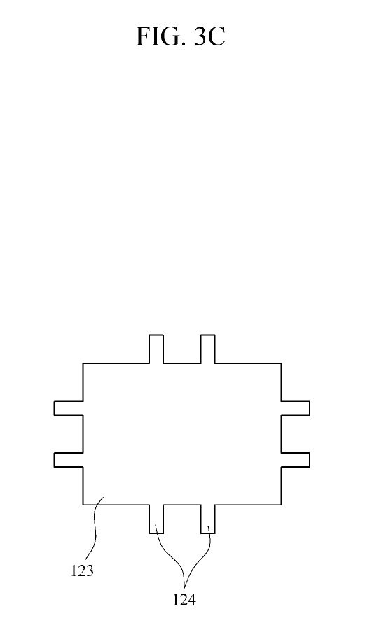

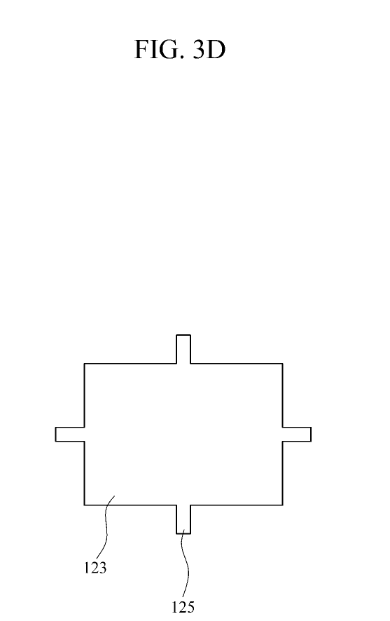

As shown in FIG. 2, the conductive pattern 122 may be formed by connecting unit cells 123, each having a conductive structure. The unit cells 123 may have an approximately half wave of a center frequency. The unit cells 123 may have a variety of shapes. For example, as shown in FIG. 3A, the unit cell 123 may have a cross-sectional area in a square shape having multiple lines 124 on each side for connection with adjacent unit cells 123. As shown in FIG. 3B, the unit cell 123 may have a cross-sectional area in a square shape having a single line 125 on each side for connection with adjacent unit cells 123.

As shown in FIG. 3C, the unit cell 123 may have a cross-sectional area having a rectangular shape having multiple lines 124 on each side for connection with adjacent unit cells 123. As shown in FIG. 3D, the unit cell 123 may have a cross-sectional area having a rectangular shape having a single line 125 on each side for connection with adjacent unit cells 123. The unit cell 123 is not limited to the above shapes and may be formed in various other shapes.

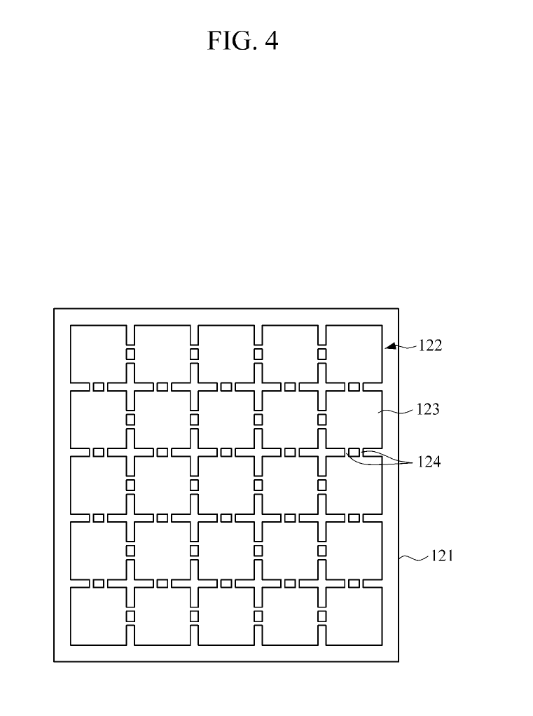

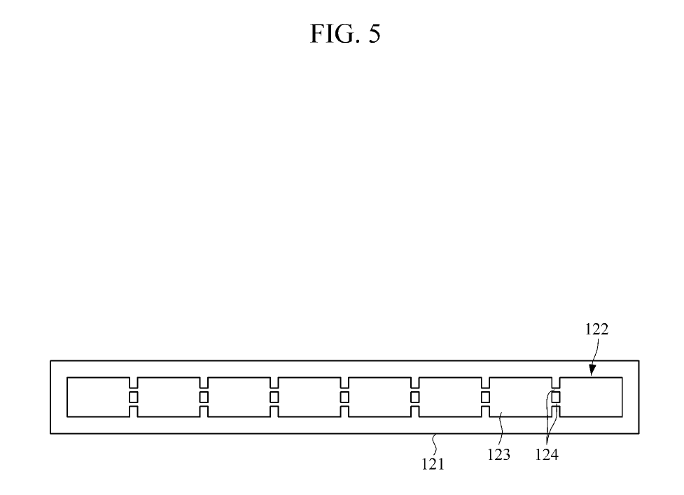

In addition, the unit cells 123 may be arranged in various forms. For example, as shown in FIG. 4, the unit cells 123 may be arranged in a matrix form having a plurality of rows and columns, being connected by the multiple lines 124. As shown in FIG. 5, the unit cells 123 may be arranged linearly, being connected with one another by the multiple lines 124. Alternatively, the unit cells 123 of FIGS. 4 and 5 may be connected with one another by single lines 125 (see FIGS. 3B and 3D).

Generally, a height from a ground plane to a superstrate of a Febry-Perot cavity (FPC) antenna is a half-wave of an operation frequency. However, in the above example, since the respective unit cells 123 operate similarly to half-wave antennas, a height of h from the ground plane 112 to the superstrate 120 may be adjustable according to the size of the unit cell 123. Hence, it is possible to design the height from the ground plane 112 to the superstrate 120 to be around 1 mm.

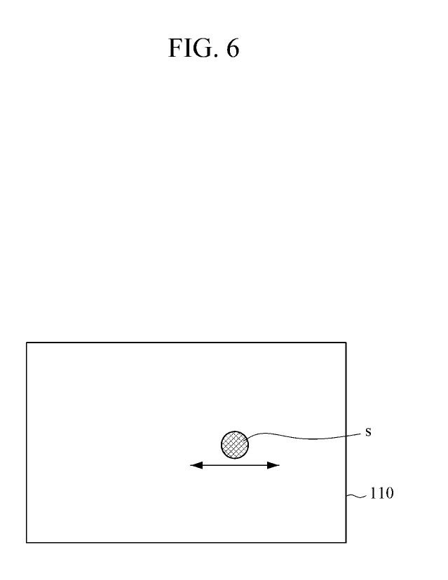

Therefore, according to the above embodiment, it is possible to design an antenna with a low profile unlike the FPC antenna. Additionally, a gain and radiation pattern of the antenna 100 is adjustable corresponding to the unit area and a shape of the antenna 100 according to the number of the unit cells 123, without changes in an operational frequency. Moreover, matching of the antenna 100, as shown in FIG. 6, may be maximally adjusted by controlling a location of a feed point S of the feed antenna 110.

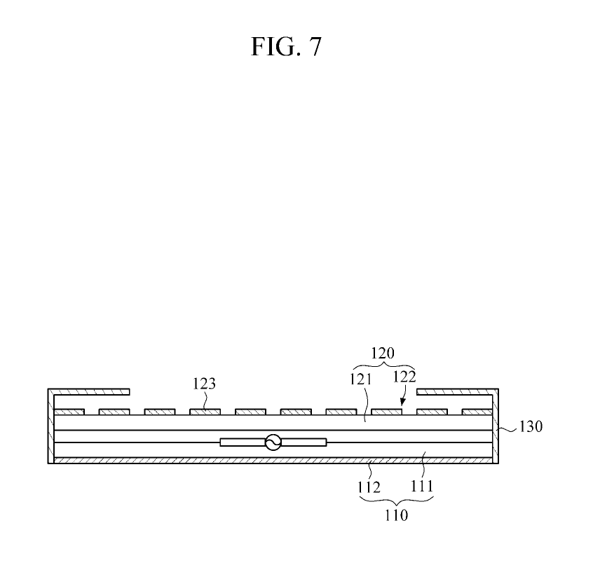

As shown in FIG. 7, the antenna 100 may further include a metal wall 130 to increase a front-to-back ratio (FBR). The metal wall 130 is formed on a periphery of each of the feed antenna 110 and the superstrate 120. For example, the metal wall 130 may be formed to surround a partial upper portion of the superstrate 120 while enclosing side surfaces of the feed antenna 110 and the superstrate 120.

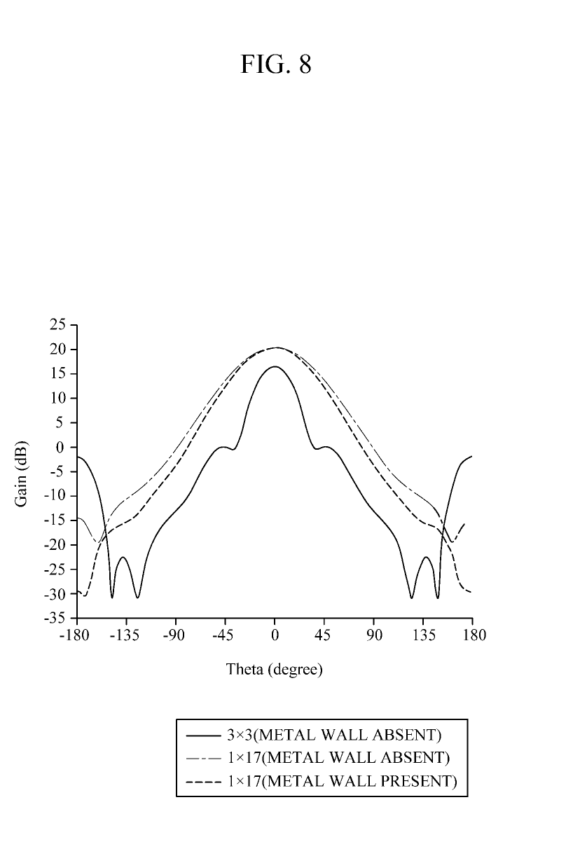

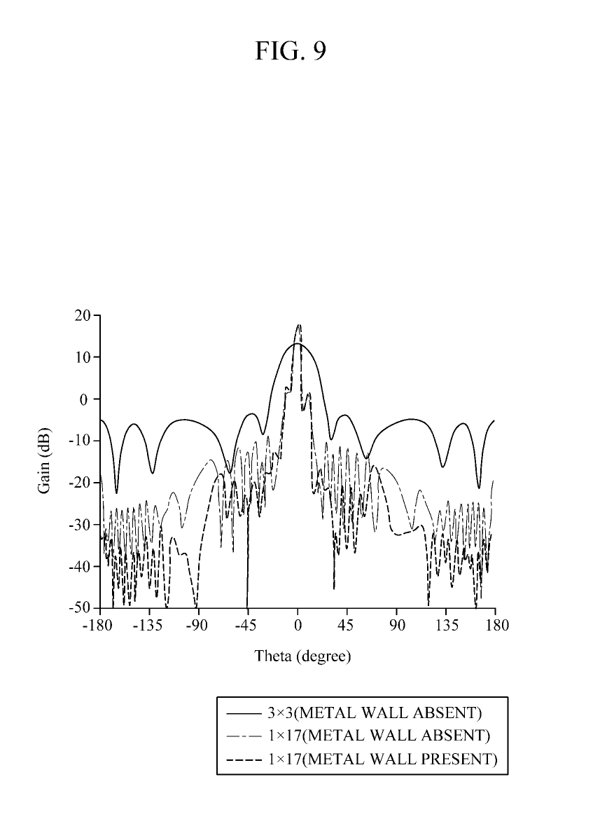

FIGS. 8 and 9 illustrate graphs showing gain cell and beam steering characteristics of an antenna with respect to the change in the number of arranged unit cells and the occurrence of a metal wall in a superstrate. FIG. 8 shows radiation characteristics of the antenna on an H-plane, and FIG. 9 shows radiation characteristics of the antenna on an E-plane.

As shown in FIGS. 8 and 9, as the length of the superstrate is longer, the beam width is shortened, and in contrast, as the length of the superstrate is reduced, the beam width is increased. That is, the beam width is adjustable according to the length of the superstrate. Moreover, a gain of the antenna is increased as the area of the superstrate is increased. That is, the gain of the antenna is adjustable according to the area of the superstrate.

An antenna including unit cells arranged in one row and seventeen columns has an advanced FBR when having a metal wall. That is, it is noted that the FBR is 35 dB when there is no metal wall but the FBR is changed to 50 dB, being increased by 15 dB, when a metal wall is present.

As described above, a superstrate having a conductive pattern is placed on an upper portion of a feed antenna, so that with only the feed antenna a gain of an antenna can be increased and beam width control can be realized. In addition, the superstrate can be formed of an inexpensive PCB, allowing easy manufacturing at low costs.

In addition, a metal wall provided to a periphery of the antenna may increase a front-to-back ratio. Thus, a feeding structure can be more simplified, compared to a case of using a general array antenna for a higher gain, and a loss of power supply to an antenna can be solved. Thus, the above described antenna may be easily applied to a base station antenna which requires a high gain, beam width control, and a high FBR.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An antenna comprising:
a feed antenna configured to feed power; and
a superstrate configured to be located on an upper portion of the feed antenna and include a conductive pattern for increasing a gain and beam width control on a surface of a dielectric substrate.

2. The antenna of claim 1, wherein the conductive pattern is formed by a plurality of unit cells being connected with one another and each of the unit cells comprises a conductive structure.

3. The antenna of claim 2, wherein each of the unit cells has a cross-sectional area in a square or rectangular shape.

4. The antenna of claim 2, wherein the unit cells are connected with one another by multiple lines or single lines.

5. The antenna of claim 2, wherein the unit cells are arranged in a plurality of rows and a plurality of columns, or in a linear pattern.

6. The antenna of claim 2, wherein the superstrate is further configured to have a height from a ground plane of the feed antenna which is adjustable according to the size of the unit cells.

7. The antenna of claim 2, wherein matching of the antenna is maximally adjustable by changing a location of a feed point of the feed antenna.

8. The antenna of claim 2, wherein a gain and radiation pattern of the antenna is adjustable corresponding to the unit area and a shape of the antenna according to the number of the unit cells, without changes in an operational frequency.

9. The antenna of claim 1, further comprising:
a metal wall configured to be provided around peripheries of the feed antenna and the substrate to increase a front-to-back ratio (FBR).

10. The antenna of claim 9, wherein the metal wall partially surrounds an upper portion of the superstrate while enclosing a side surface of the feed antenna and a side surface of the superstrate.

11. The antenna of claim 1, wherein the feed antenna is configured to be one of a patch antenna, a dipole antenna, a slot antenna, and a waveguide antenna.
